(19) United States
(12) Patent Application Publication
(10) Pub. No.: US 2024/0353110 A1
(43) Pub. Date: Oct. 24, 2024

(54) AN OVEN

(71) Applicant: SER DAYANIKLI TUKETIM MALLARI IC VE DIS TICARET SANAYI ANONIM SIRKETI, Zeytinburnu, Istanbul (TR)

(72) Inventor: Mustafa USTAOGLU, Zeytinburnu, Istanbul (TR)

(21) Appl. No.: 18/685,586

(22) PCT Filed: Aug. 17, 2022
(86) PCT No.: PCT/TR2022/050868

§ 371 Date: Feb. 22, 2024

(30) Foreign Application Priority Data
Oct. 22, 2021 (TR) 2021/016449

(51) Int. Cl. F24C 15/02; A47J 37/06; F24C 15/04

(52) U.S. Cl. CPC F24C 15/023; F24C 15/021; F24C 15/04; A47J 37/0623

(57) ABSTRACT

Disclosed is an oven, which has two doors connected side by side with hinges on the user-facing surface of a main body in a rotational manner around a vertical axis, and includes a movement mechanism that enables the said doors to be opened simultaneously.

### TECHNICAL FIELD

The present invention relates to an oven which has two doors connected side by side with hinges on the user-facing surface of a body in a way that can be rotated about the vertical axis and includes a movement mechanism that enables the said doors to be opened simultaneously.

### PRIOR ART

The oven doors in the state of the art are generally opened from top to bottom by rotating around an axis parallel to the ground plane. This said door is pulled outwards by being held from the upper side, and it comes to the fully open position by turning on the horizontal rotation axis located at the lower edge. In case the kitchen is narrow or the space to put the oven is small, the space occupied by the fully open door may pose a problem for the user. In cases where the oven door is fully open, it is very difficult for the user to reach the cooking volume inside the door. In order to solve the problem of opening the door on an axis parallel to the ground plane, nowadays there are single-door or double-door ovens that open perpendicular to the ground plane. The doors in the said ovens can work synchronously with respect to each other, so when the user opens one door of the oven with one hand, the other door can be opened synchronously and with the other hand, the user can place the food to be cooked in the oven. The biggest technical problem in this type of synchronous doors is that the said doors cannot provide sealing and do not fit properly.

In the United States patent application document No. 2015137675, which is in the state of the art, a rotary-mounted double-door oven is disclosed. The pair of doors are connected by a coupling assembly so that the doors open and close simultaneously. The coupling assembly includes a spur gear engaged with another gear of the coupling assembly. The spur gear can prevent unwanted rotation of the door pair or press the door pair against a gasket.

A double-door oven is disclosed in the United States patent application document No. 2014283811, which is found in the state of the art. A pair of sprockets or gear, a pair of chains and a pair of connection components connect the doors to open and close simultaneously. The oven also includes characteristics to limit or eliminate contact between the connection components at a point where the connection components intersect each other.

### OBJECTS OF THE INVENTION

The object of the present invention is to realize an oven whose doors are adapted to be opened synchronously.

Another object of the present invention is to realize a sealing oven.

Another object of the present invention is to realize an oven comprising an oven door that can remain stationary as long as no force is applied in its opened position.

### BRIEF DESCRIPTION OF THE INVENTION

The oven as defined in the first claim and other claims depending on this claim, realized in order to achieve the aim of the present invention, consists of at least one main body and two doors. These doors can be opened and closed synchronously. While the doors maintain their position in the fully closed state by means of a flexible element and a second stopper, if the user opens the door, the door maintains its position in the fully open position by means of a first stopper. In this way, the free movement of the door is prevented, and the possibility of the user hitting the door while putting food into the chamber is minimized.

### DETAILED DESCRIPTION OF THE INVENTION

The oven realized to achieve the aim of the present invention is shown in the attached figures, in which;

FIG. 1. is a perspective view of the oven.

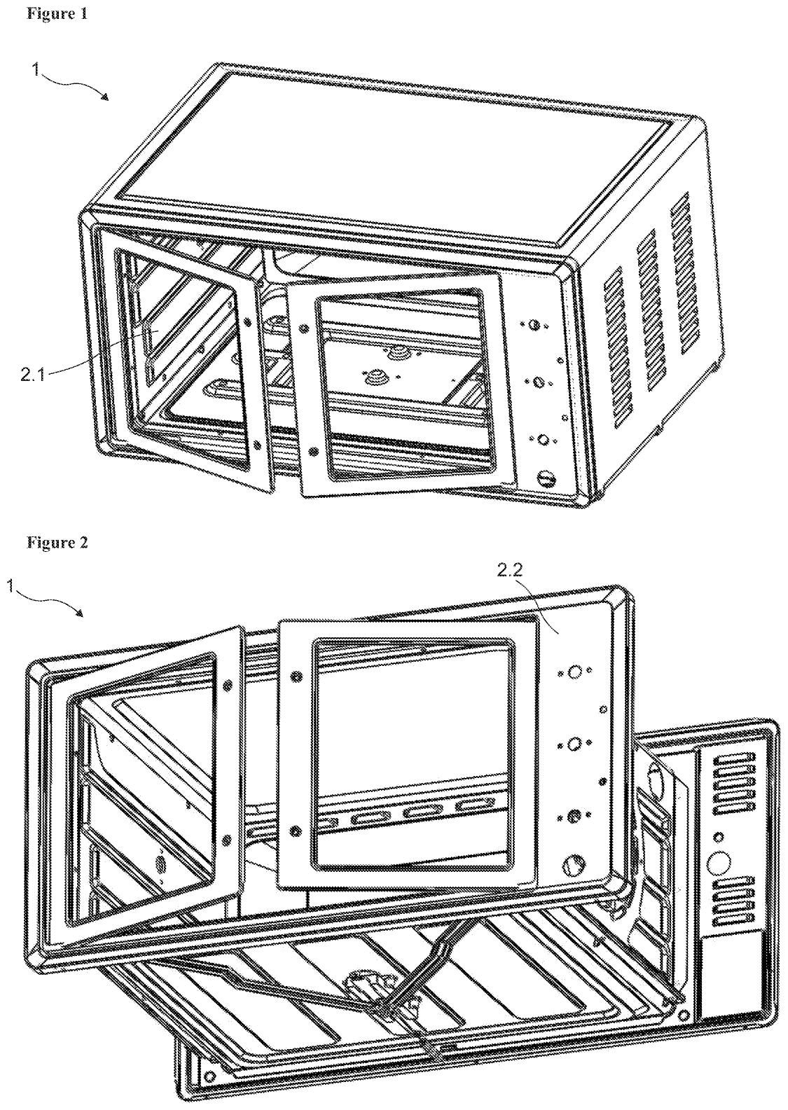

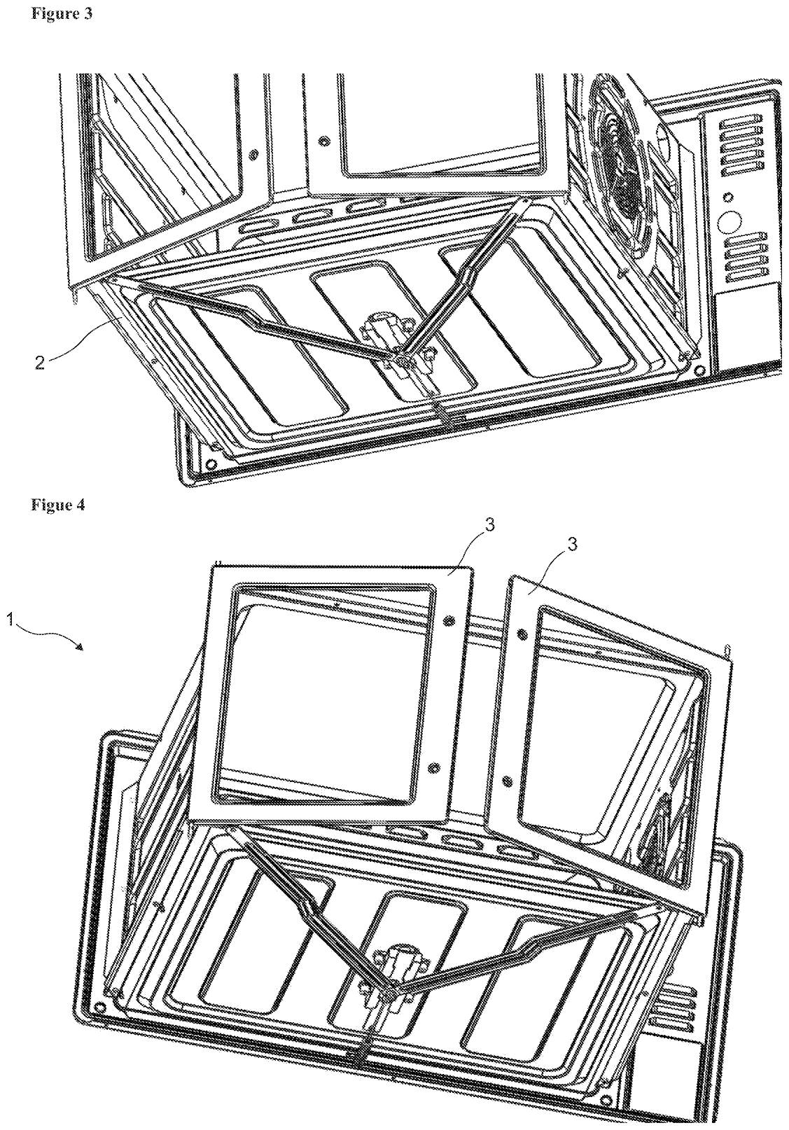

FIG. 2. is a perspective view of the oven from another angle.

FIG. 3. is a perspective view of the oven from another angle.

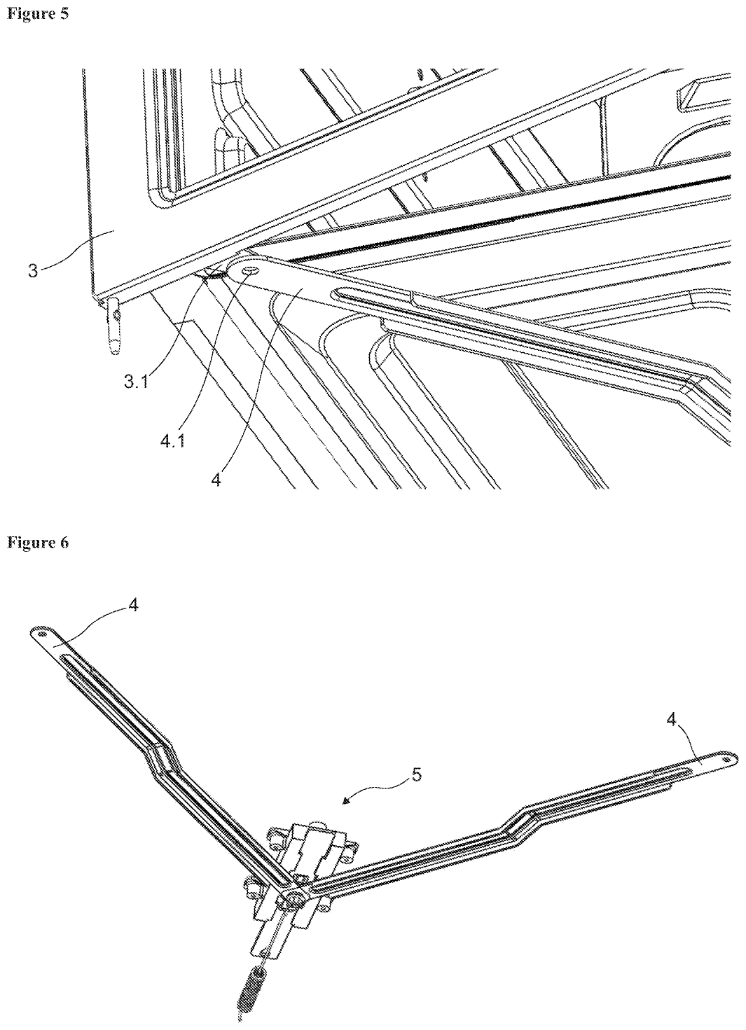

FIG. 4. is a perspective view of the oven from another angle.

FIG. 5. is a zoomed-in perspective view of the door and the guide lever.

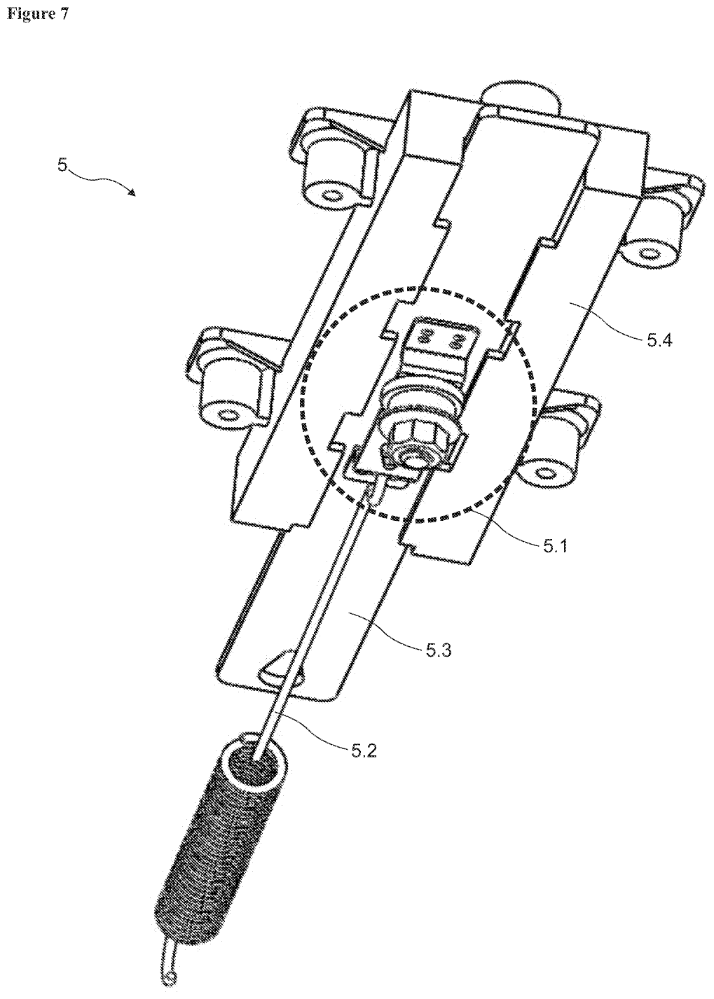

FIG. 6. is a perspective view of the guide levers and the motion control group.

FIG. 7. is a perspective view of the motion control group.

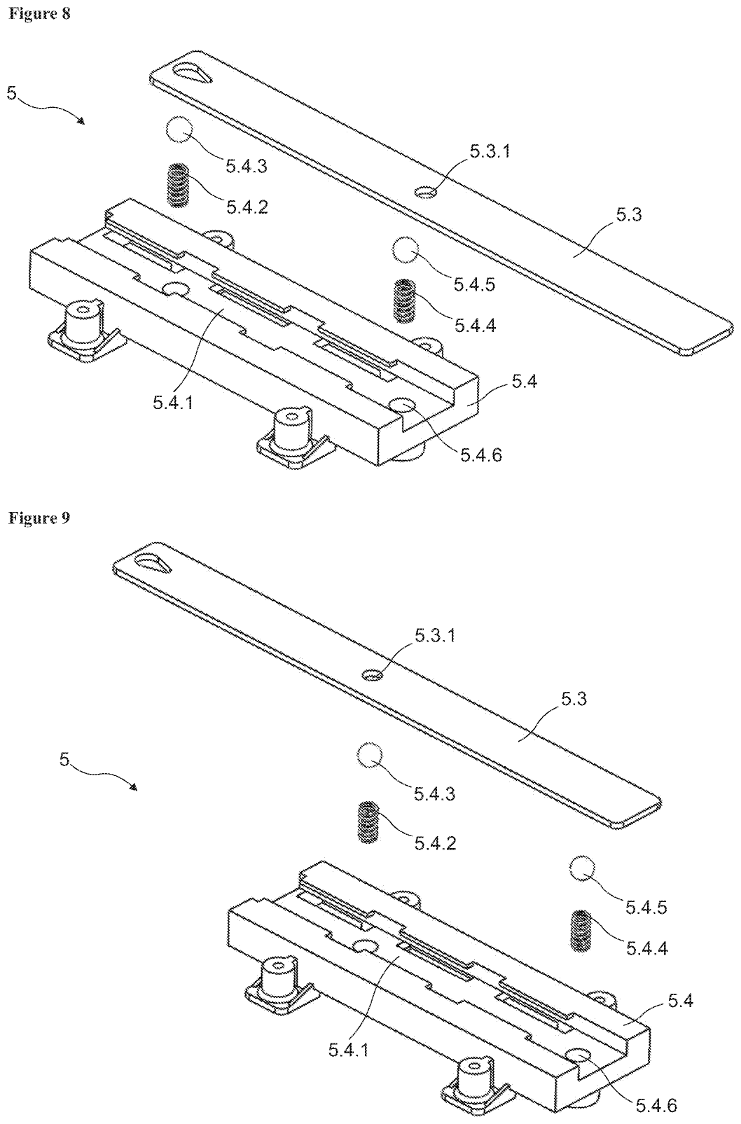

FIG. 8. is an exploded perspective view of the motion control group, with the door in open state.

FIG. 9. is an exploded perspective view of the motion control group, with the door in closed state.

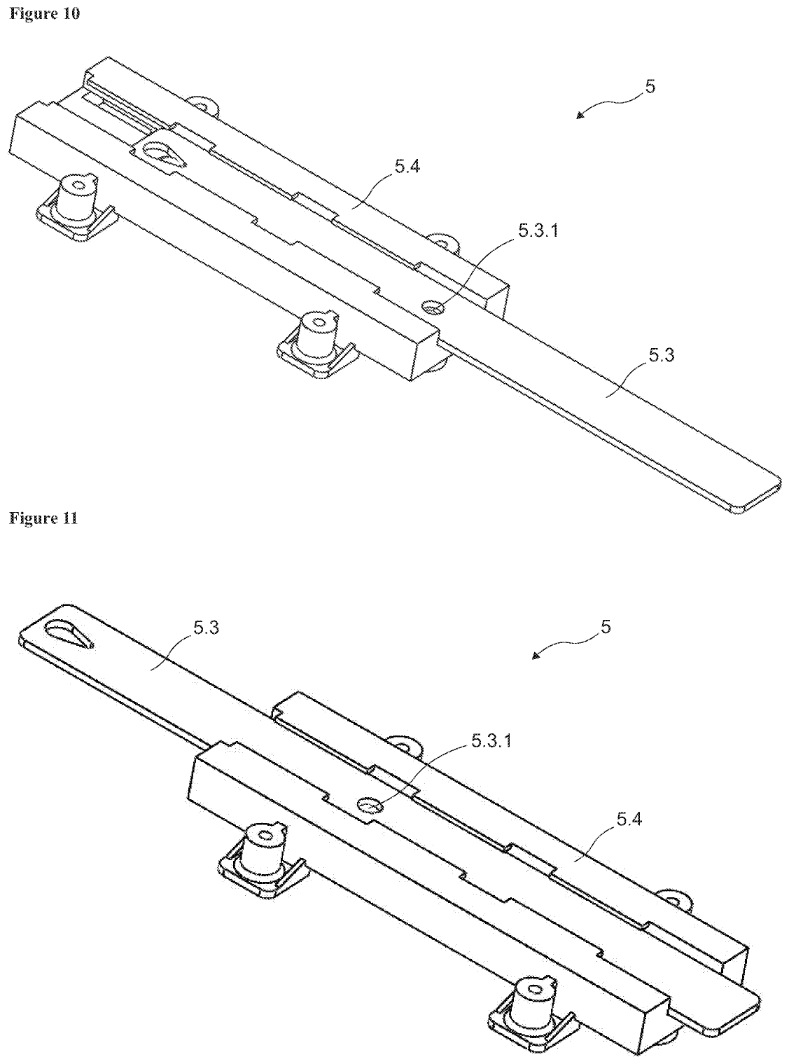

FIG. 10. is a perspective view of the motion control group, with the door in open state.

FIG. 11. is a perspective view of the motion control group, with the door in closed state.

The components given in the figures are enumerated individually, and the meanings of these numbers are given below.
1. Oven
2. Main body
   2.1. Chamber
   2.2. Front face
3. Door
   3.1. Connection protrusion
4. Guide lever
   4.1. Hole
5. Motion control group
   5.1. Connection group
   5.2. Flexible element
   5.3. Positioning plate
      5.3.1. Positioning hole
   5.4. Stationary body
      5.4.1. Channel
      5.4.2. First flexible element
      5.4.3. First stopper
      5.4.4. Second flexible element
      5.4.5. Second stopper
      5.4.6. Groove

An oven (1) for heating or cooking of food, in its most basic form, comprising:
at least one main body (2), which has a chamber (2.1) therein, and the front face (2.2) of which is adapted to be open, for food to be cooked within the said chamber (2.1),
at least two doors (3) placed on the front face (2.2) found in the main body (2) and allowing the chamber (2.1) to be closed, and opened in opposite directions to each other on a perpendicular axis to the ground plane,
at least two guide levers (4), which are adapted, when a force is applied to open one of the doors (3), to trigger the other door to open synchronously with the door (3) on which the force is applied,
a connection group (5.1) connecting the guide levers (4) to each other, which connect the guide levers (4) to each other and when force is applied to a door (3) in the opening or closing direction, also trigger the other door (3) to make synchronous movement,
   at least one flexible element (5.2), one end of which is mounted to the connection group (5.1) and the other end to the main body (2), which ensures sealing by applying force to the doors (3) by means of the guide lever (4) in the direction of keeping the doors (3) continuously closed,
   at least one positioning plate (5.3) which can move synchronously with the connection group (5.1) and guide levers (4) and having a positioning hole (5.31) thereon to keep the doors (3) in the open position when opened and in the closed position when closed,
   a motion control group (5) having a stationary body (5.4) comprising a first stopper (5.43) mounted on the main body (2), having a channel (5.41) for allowing the positioning plate (5.3) to move, and that can be placed in the positioning hole (5.31) to maintain its current position when the doors (3) are in the closed position, and a first flexible element (5.42) that exerts thrusting force on this first stopper (5.43), and also, a second stopper (5.45) that can be inserted into the positioning hole (5.31) to maintain the open position when the doors (3) are brought to the open position; and a second flexible element (5.44) that exerts thrusting force on this second stopper (5.45).

The oven (1) in an embodiment of the invention most generally consists of a main body (2) and two doors (3). Said oven (1) contains a chamber (2.1) in which food is cooked or heated. All sides of the chamber (2.1) are in the closed position and only the front side (2.2) is in the open position. The user places the product from the front (2.2) into the chamber (2.1) and performs the heating or cooking process in this way. Closing the front side (2.2) is accomplished by means of two doors (3). Said doors (3) are adapted to rotate around an axis perpendicular to the ground plane on both sides of the front face (2.2). The doors (3) are fixed to the main body (2) by means of hinges at the said axis, and when the user wants to open the doors (3), the user applies a pulling force and in this way, the doors (3) are opened by rotating around the said axis. The synchronous opening and closing of the doors (3) is carried out by means of the guide levers (4) mounted to the doors (3) from the connection protrusion (3.1). In the oven (1) according to this embodiment of the invention, the guide levers (4) are placed on the lower part of the main body (2), and a guide lever (4) is mounted on both doors (3). One end of the guide lever (4) is mounted to the connection protrusion (3.1) on the door (3) through a hole (4.1), and the other end is mounted to the connection group (5.1) located in the motion control group (5). In this embodiment of the invention, one guide lever (4) is mounted on each door (3) and the guide levers (4) are moved to make the same angle with respect to the central axis of the main body (2). In this way, it is ensured that the doors (3) can be opened and closed synchronously.

The synchronous movement of the guide levers (4) connected to the doors (3) in this embodiment of the invention is carried out by the movement control group (5). The motion control group (5) basically consists of a connection group (5.1), a flexible element (5.2), a positioning plate (5.3) and a stationary body (5.4). The connection group (5.1) in the motion control group (5) is the element where both guide levers (4) are connected to each other, and when a force is applied to a door (3), the guide lever (4) connected to that door (3) transmits this movement to the connection group (5.1), and since the other door (3) is mounted on this connection group (5.1) on the guide lever (4), both doors move synchronously. There is a flexible element (5.2) in the motion control group (5) that continuously pulls the movement of the connection group (5.1) in one direction. This flexible element (5.2) in this embodiment of the invention is a spring and applies a continuous pulling force to the connection group (5.1) and thus forces the doors (3) to remain closed continuously. In this way, the doors (3) are fully seated on the front surface (2.2) and sealing is ensured. The connection group (5.1) and thus the guide levers (4) are moved back and forth smoothly in the direction of the central axis of the main body (2) by means of the positioning plate (5.3), which can move back and forth in the channel (5.41). The positioning plate (5.3) and the connection group (5.1) are rigidly connected to each other and both move together. At least one positioning hole (5.31) is drilled in the positioning plate (5.3). This said positioning hole (5.31) is the part ensuring that the doors (3) mounted on the stationary body (5.4) stay in the preferred position, where the first stopper (5.43) and the second stopper (5.45) are fitted. In this way, it is ensured that the doors (3) remain in a preferred position.

There is also a stationary body (5.4) in the motion control group (5) included in this embodiment of the invention. This stationary body (5.4) is mounted on the lower part of the main body (2). There is a channel (5.41) in the middle part of the stationary body (5.4), and the said channel (5.41) is opened in the stationary body (5.4) so that the positioning plate (5.3) can move freely in the direction of the central axis of the main body (2). The positioning plate (5.3) and the connection group (5.1) can move back and forth in this channel (5.41), and in this way, smooth movements of the doors (3) both in the opening direction and in the closing direction are provided. At least two grooves (5.46) are opened in the channel (5.41) in the stationary body (5.4). While the first flexible element (5.42) and the first stopper (5.43) are mounted on one of these grooves (5.46), the second flexible element (5.44) and the second stopper (5.45) are mounted on the other. Firstly, the first flexible element (5.42) and the second flexible element (5.44) are mounted in the grooves (5.46), and then the first stopper (5.43) and the second stopper (5.45) are placed. The first flexible element (5.42) and the second flexible element (5.44) continuously apply pressure to the first stopper (5.43) and the second stopper (5.45) in the direction of the positioning plate (5.3). In this way, the first stop (5.43) and the second stop (5.45) are squeezed between the first flexible element (5.42) and the second flexible element (5.44) and the positioning plate (5.3), and when the positioning hole (5.31) and the first stop (5.43) or the second stop (5.45) are aligned, the first stopper (5.43) or the second stopper (5.45) slightly enter into the positioning hole (5.31). In this case, the movement of the positioning plate (5.3) is restricted and only if the user applies a force to the door (3), the said first stopper (5.43) or the second stopper (5.45) comes out of the positioning hole (5.31) and the movement of the positioning plate (5.3) is provided.

In this embodiment of the invention, the doors (3) in the oven (1) come to the fully open position from the fully closed position and stay in this position, as well as turning from the fully open position to the closed position and stopping in this position as follows. When the doors (3) are closed, the positioning plate (5.3) is in its initial position. In the said position, the flexible element (5.2) ensures that the doors are fully closed and sealed by applying a pulling force, and in addition, the first stopper (5.43) is somewhat inserted into the positioning hole (5.31) (FIG. 11). In this way, it is ensured that the doors (3) maintain their position by means of both the flexible element (5.2) and the first stopper (5.43). If the user prefers to open the door (3), the user applies a force to any door (3) in the opening direction, and in this case, the doors (3) start to rotate synchronously around their rotation axes. In this case, the positioning plate (5.3) starts to move due to the force applied by the user to the door (3) which is more than the force applied by the flexible element (5.2) in the pulling direction, and the second stopper (5.45) fits into the positioning hole (5.31). (FIG. 10). In the case where the user brings both doors (3) to the fully open position by applying force to one of the doors (3), the second stopper (5.45) fits into said positioning hole (5.31) and the current position of the door (3) is maintained until the user applies force to the door (3) again. If it is preferred to move the door (3) again, the user applies a force to the door (3) again, and in this case, the second stopper (5.45) is released from the positioning hole (5.31) and the door (3) returns to the closed position through the pulling force of the flexible element (5.2).

1. An oven for heating or cooking of food, the oven comprising:
at least one main body, which has a chamber therein, and a front face of which is adapted to be open, for food to be cooked within said chamber;
at least two doors placed on the front face found in the main body and allowing the chamber to be closed, and opened in opposite directions to each other on a perpendicular axis to the ground plane;
at least two guide levers, which are adapted, when a force is applied to open one of the doors, to trigger the other door to open synchronously with the door on which the force is applied;
a connection group connecting the guide levers to each other, which connect the guide levers to each other and when force is applied to a door in the opening or closing direction, also trigger the other door to make synchronous movement;
at least one flexible element, one end of which is mounted to the connection group and the other end to the main body, which ensures sealing by applying force to the doors by means of the guide lever in the direction of keeping the doors continuously closed;
at least one positioning plate which can move synchronously with the connection group and guide levers and having a positioning hole thereon to keep the doors in the open position when opened and in the closed position when closed;
a motion control group having a stationary body comprising a first stopper mounted on the main body, having a channel for allowing the positioning plate to move, and that can be placed in the positioning hole to maintain its current position when the doors are in the closed position, and a first flexible element that exerts thrusting force on this first stopper, and also, a second stopper that can be inserted into the positioning hole to maintain the open position when the doors are brought to the open position; and a second flexible element that exerts thrusting force on this second stopper.

2. The oven according to claim 1, wherein the motion control group comprises the connection group, the flexible element, the positioning plate and the stationary body.

3. The oven according to claim 1, wherein the connection group, which is the element where both guide levers are connected to each other, and when a force is applied to the door, transmitting the movement of the guide lever connected to that door and allowing the other guide lever to be moved synchronously.

4. The oven according to claim 1, wherein the flexible element constantly pulls the movement of the connection group in one direction, and which is a spring that forces the doors to remain closed by applying a continuous pulling force to the connection group.

5. The oven according to claim 1, wherein the positioning plate is mutually rigid with the connection group and enables the guide levers to be moved back and forth in the direction of the main body center axis and within the channel.

6. The oven according to claim 1, wherein the positioning hole is the part where the first stopper and the second stopper are fitted, and which opens in the positioning plate and ensures that the doors mounted on the stationary body stay in the preferred position.

7. The oven according to claim 1, wherein the channel is opened in the middle part of the stationary body and allows the positioning plate to move freely in the direction of the central axis of the main body.

8. The oven according to claim 1, wherein the channel provides smooth movements of the doors both in the opening direction and in the closing direction by moving back and forth inside the positioning plate and the connection group.

9. The oven according to claim 1, comprising a groove, at least two of which are opened in the channel found in the stationary body, and one of which being mounted with the first flexible element and the first stopper and the other one being mounted with the second flexible element and the second stopper.

10. The oven according to claim 1, comprising a groove in which the first flexible element and the second flexible element are mounted first, and then the first stopper and the second stopper are placed.

11. The oven according to claim 1, wherein the first flexible element continuously presses the first stopper in the direction of the positioning plate.

12. The oven according to claim 1, wherein the second flexible element continuously presses the second stopper in the direction of the positioning plate.

13. The oven according to claim 1, wherein the first stopper gets stuck between the first flexible element and the positioning plate and slightly enters the positioning hole when it aligns with the positioning hole.

14. The oven according to claim 1, wherein the second stopper gets stuck between the second flexible element and the positioning plate and slightly enters the positioning hole when it aligns with the positioning hole.
